(19) United States
(12) Patent Application Publication
(10) Pub. No.: US 2008/0278621 A1
(43) Pub. Date: Nov. 13, 2008

(54) Camera module

(75) Inventors: Jae Sub Cho, Gyeonggi-do (KR); Jung Jin Kim, Gyeonggi-do (KR); Jin Mun Ryu, Gyeonggi-do (KR); Bo Kyoung Kim, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/149,834

(22) Filed: May 8, 2008

(30) Foreign Application Priority Data
May 10, 2007 (KR) 10-2007-0045658

(51) Int. Cl. H04N 5/225

(52) U.S. Cl. 348/374; 348/E05.024; 348/340

(57) ABSTRACT

The present invention relates to a camera module capable of being surface mounted (SMT) on a main substrate.

In accordance with the present invention, the camera module includes a housing provided with a cylindrical barrel coupling unit extended upward from a central part of the housing, wherein a female screw unit is formed on an inner circumferential surface of the cylindrical barrel coupling unit and an opening unit is formed on a top portion of the cylindrical barrel coupling unit; a lens barrel provided with a male screw unit on an outer circumferential surface by being formed in a cylindrical shape to be conformally combined with the barrel coupling unit and screw-coupled to the female screw unit by being inserted through the opening unit of the barrel coupling unit; a wafer lens mounted in the lens barrel; and a substrate with an image sensor mounted on a top surface of the substrate by a wire bonding and closely coupled to a lower part of the housing by being provided with surface mounting pads on each lateral surface thereof and has advantages that the process for mounting the camera module onto the substrate is simplified and further a process cost is reduced by removing an additional connection device for electrically connecting the camera module to the main substrate.

### CROSS-REFERENCE TO RELATED APPLICATIONS

This application claims the benefit of Korean Patent Application No. 10-2007-0045658 filed with the Korea Intellectual Property Office on May 10, 2007, the disclosure of which is incorporated herein by reference.

### BACKGROUND OF THE INVENTION

1. Field of the Invention

The present invention relates to a camera module capable of being surface mounted (SMT) on a main substrate; and, more particularly, to a camera module capable of being surface mounted on a main substrate by using a solder cream with passing through a reflow by mounting a wafer lens in a lens barrel and forming pads in a lower part of a substrate closely adhered to a lower part of a housing.

2. Description of the Related Art

Currently, when producing a motor car and an endoscope or the like including IT (Information Technology) equipment such as a mobile communication terminal, a PDA (Personal Digital Assistant) and a MP3 player or the like, a camera module has been mounted. Such a camera module has been made smaller and thinner according to mounting objects with being developed from existing 300 thousand pixels (VGA level) with respect to high pixel as technological development and has been changed to realize various additional functions such as auto-focusing (AF), optical zoom or the like at a low manufacturing cost.

Such a camera module is mainly manufactured in a state that an image sensor such as a CCD (Change-Coupled Device) or a CMOS (Complementary Metal-Oxide Semiconductor) is mounted on a substrate by a wire bonding method or a flip chip method and an image of an object is condensed through the image sensor and stored as data on a memory inside and outside the camera module and the stored data is converted into an electric signal to be displayed as an image through a display medium such as an LCD (Liquid Crystal Display) monitor or a PC (Personal Computer) monitor in equipment.

Hereinafter, a structure of a camera module manufactured by a COB (Chip Of Board) method as a representative method for manufacturing a camera module will be briefly described with reference to the accompanying drawings.

FIG. 1 is an exploded perspective view showing a camera module manufactured by the conventional COB method and FIG. 2 is a schematic cross-sectional view showing the camera module manufactured by the conventional COB method. The conventional camera module 10 is manufactured by coupling a print substrate 11 mounted an image sensor 12 such as a CCD or a CMOS thereon by a wire bonding method to a lower part of a housing 13 made of a plastic material and coupling a lens barrel 16 of which a cylindrical body 15 is extended downward to a body tube 14 extended to an upper part of the housing 13.

In the camera module 10, the housing 13 and the lens barrel 16 are coupled by screw-coupling a female screw unit 14a formed on an inner circumferential surface of the body tube 14 and a male screw unit 15a formed on an outer circumferential surface of the cylindrical body 15.

At this time, an IR (Infra Red) filter 18 is mounted between a lens L mounted above the print substrate 11, that is, on a lower part of the lens barrel 16 and the image sensor 12 attached on the print substrate 11 to block excessive infrared rays with a long wave inputted into the image sensor 12.

In the above assembled camera module, a phase is inverted and focused on a surface of the image sensor 12 with light inputted from a specific object passing through the lens L and at this time. At this time, an adhesive is poured between the housing 13 and the lens barrel 16 at a spot at which an optimal focus is adjusted with rotating the lens barrel 16 coupled to a top stage of the housing 13 by screw coupling and the housing 13 and the lens barrel 16 are adhere and fixed, whereby a final camera module product is manufactured.

Further, a presently manufactured camera module is produced by mounting an image sensor module manufactured by a flip chip method (COF; Chip Of Flexible) and a CSP (Chip Scale Package) method other than the wire bonding method (COB: Chip Of Board), wherein the camera module is mainly connected to a main substrate through an electric connection device such as a printed circuit board (PCB) or a flexible printed circuit board (FPCB) or the like.

However, recently, has been required from a user a camera module capable of being directly surface-mounted on a main substrate the same as a general passive component, that is, capable of simplifying a bonding process by being fixed through a reflow after being received on the main substrate without an additional electric connection device.

To satisfy the above mentioned need, a camera module capable of fixing leads extended outside the camera module onto a main substrate (Japanese Laid-Open Publication No. 2000-247884) has been developed and hereinafter, the structure thereof is described in brief.

FIG. 3 is a cross-sectional view showing a conventional camera module. As shown in the drawing, a solid-state imaging device 2 is installed inside an integral lens holder 4, a plurality of leads 7 are connected on all sides of the solid-state imaging device 2 through an electrode 6, and a lens 5 is received on a top part of the lens holder.

At this time, the leads 7 are protruded outside the integral lens holder 4 and one ends thereof are bent.

Because in the conventional camera module with the above technical configuration, the leads 7 protruded outside the lens holder 4 are connected on a main substrate of a terminal, any connection device such as a connector or a socket to electrically connect the camera module is not required, however the configuration is complicated and also a normal operation is performed only when all the leads 7 are electrically connected to the imaging device 2 through the electrode 6, and therefore it is difficult to continuously maintain the reliability thereof.

Further, the method for manufacturing the conventional camera module is complicated and the imaging device 2, the substrate and a part of leads 7 are installed inside the integral lens holder 4 and thus, when connection error of the leads 7, the substrate 1 and the imaging device 2 occurs, there is nothing for it but to discard a finished product, thereby increasing a loss cost.

### SUMMARY OF THE INVENTION

The present invention has been invented in order to overcome the above-described various disadvantages and problems of the conventional camera module. It is, therefore, an object of the present invention to provide a camera module capable of being directly surface mounted with being received on a main substrate of a mounting terminal in a state that a solder cream is interposed and passing through a reflow by mounting a high heat resistant wafer lens in a lens barrel and forming surface mounting pads on a substrate mounted an image sensor thereon.

Further, it is, therefore, another objection of the present invention to prevent the camera module from being deformed due to heat applied in the reflow when passing through the reflow for soldering-bonding of the substrate after being received on the main substrate by forming a lens and a lens barrel mounted the lens thereon and a housing coupled the lens barrel thereto with a high heat resistant material.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is an exploded perspective view showing a camera module manufactured by a conventional COB method;

FIG. 2 is a schematic cross-sectional view showing a camera module manufactured by a conventional COB method;

FIG. 3 is a cross-sectional view showing a conventional camera module;

FIG. 4 is an assembly perspective view showing a camera module in accordance with the present invention;

FIG. 5 is a cross-sectional view showing a camera module in accordance with the present invention;

FIG. 6 is a cross-sectional view illustrating a camera module in accordance with another embodiment of the present invention; and

FIG. 7 is a flowchart illustrating a method for manufacturing a wafer lens adopted in a camera module in accordance with the present invention.

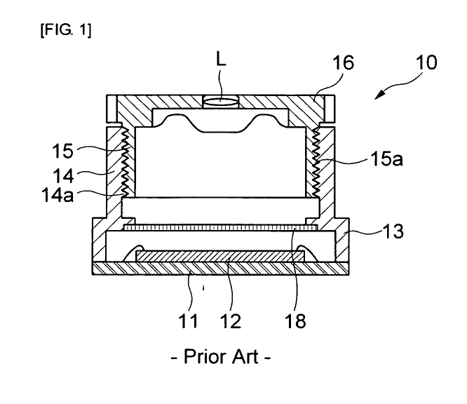

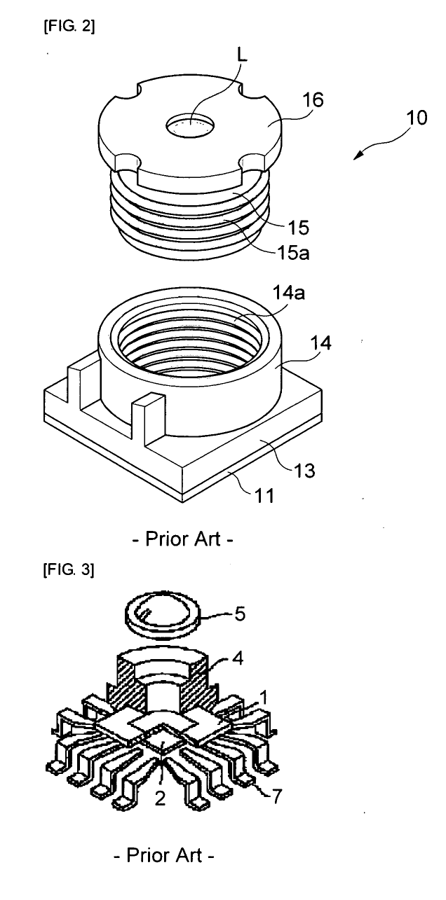

### DETAILED DESCRIPTION OF THE PREFERRED EMBODIMENTS

The objects of the present invention can be achieved by providing a camera module including a housing with a cylindrical barrel coupling unit extended upward from a central part of the housing, wherein an opening unit is formed on a top portion of the cylindrical barrel coupling unit; a lens barrel inserted through the opening unit of the barrel coupling unit; a wafer lens mounted in the lens barrel; and a substrate with an image sensor mounted on a top surface of the substrate by wire bonding and closely adhered to a lower part of the housing by being provided with surface mounting pads on each lateral surface thereof.

In the housing, a female screw unit is formed on an inner circumferential surface of the barrel coupling unit extended upward.

Further, the lens barrel coupled to the housing is formed in a cylindrical shape to be conformally combined in the barrel coupling unit and provided with a male screw unit on an outer circumferential surface.

And, a disk-shaped cap formed on a top part of the lens barrel supports a top surface of the wafer lens mounted inside the lens barrel and plays a rotator role during assembling in the housing or focusing after assembling at the same time.

The wafer lens mounted inside the lens barrel is manufactured by injection molding through a replica method in a wafer level state, wherein the wafer lens is cut into a square-shaped unit wafer lens and mounted inside the lens barrel.

At least one wafer lens is stacked and coupled in the lens barrel and fixed by closely coupling a pressurizing ring on a bottom part of the wafer lens. At this time, the wafer lens is pressed to the pressurizing ring and fixed by being fixed through injection of an adhesive and by being fused through ultrasonic irradiation outside the lens barrel at the same time.

And, the wafer lens includes an IR (Infra Red) coating layer on any one of a top surface and a bottom surface.

The substrate is mounted the image sensor on a top surface thereof and wire-bonded and may include surface mounting pads extended from a lateral surface to a lower surface of the substrate or a solder ball and a bump or the like.

Inside the housing, an IR filter to block infrared rays included in the light impinged through the lens may be included when there is not the IR coating layer on the wafer lens.

Meanwhile, the housing and the lens barrel are injection-molded by a high heat resistant material.

Hereinafter, a subject regarding to a technical configuration and an operation effect thereof corresponding to the above object of a camera module in accordance with the present invention will be appreciated clearly through the following detailed description with reference to the accompanying drawings illustrating preferable embodiments of the present invention.

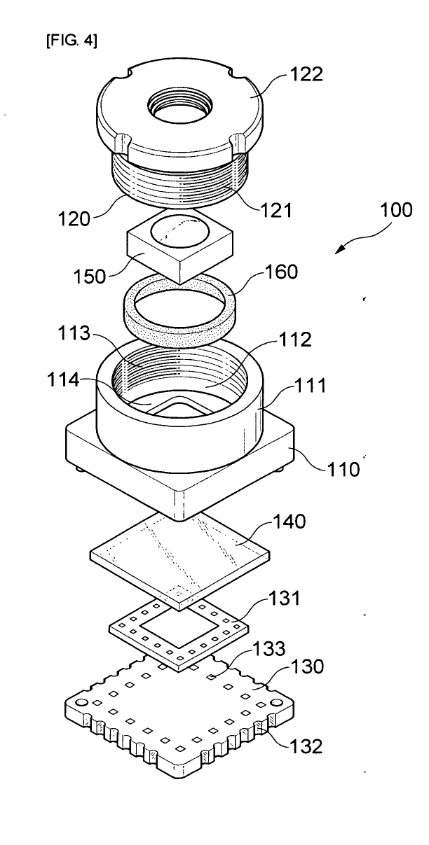

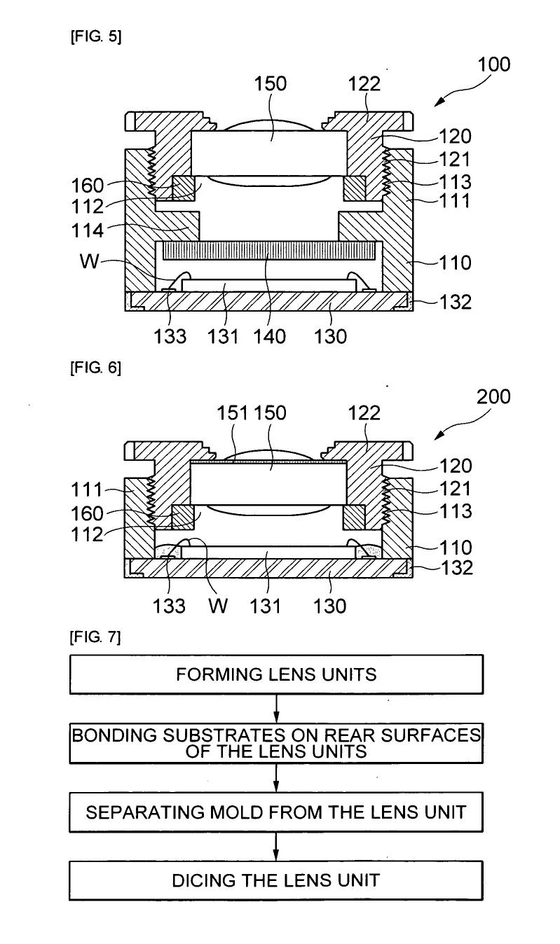

First of all, FIG. 4 is an assembly perspective view showing a camera module in accordance with the present invention and FIG. 5 is a cross-sectional view showing a camera module in accordance with the present invention.

As shown in the drawings, in accordance with the present invention, the camera module 100 includes a housing 110; a lens barrel 120 coupled on an upper part of the housing 110; and a substrate 130 closely adhered on a lower part of the housing 110.

On the central part of the housing 110, a cylindrical barrel coupling unit 111 is protruded and extended upward and a female screw unit 113 is provided on an inner circumferential surface of the barrel coupling unit 111.

Further, the housing 110 is injection-molded by a high heat resistant material capable of standing a heating temperature of around 150° C., a glass type IR filter 140 is mounted at an arbitrary spot inside the housing, and a rib 114 is formed at a spot where the IR filter 140 is mounted to support the IR filter.

The barrel coupling unit 113 has an opening unit 112 on a top part and the cylindrical lens barrel 120 is inserted through the opening unit 112. A male screw unit 121 is formed on an outer circumferential surface of the lens barrel and screw-coupled inside the barrel coupling unit 111. The lens barrel 120 is moved up and down inside the barrel coupling unit 111 by rotation of the lens barrel 120 about a screw coupling spot.

At this time, the rotation of the lens barrel 120 is performed on the whole by rotating the disk-shaped cap 122 formed on the top part of the lens barrel.

Meanwhile, a wafer lens 150 is adopted inside the lens barrel 120, wherein a top surface of the wafer lens 150 is supported by an intrados of the cap 122 and a bottom surface thereof is supported by a pressurizing ring 160 inserted through a lower part of the lens barrel 120.

At this time, the wafer lens 150 is elastically supported by the pressurizing ring 160 with desired elasticity and firmly fixed by coating an additional adhesive on top and bottom parts of the pressurizing ring 160 and hardening the adhesive at the same time.

Further, the wafer lens 150 may be bonded and fixed by fusing an interface thereof through ultrasonic waves or a laser irradiated outside the lens barrel 120 other than the pressurizing ring 160 as a fixing device thereof.

Herein, the wafer lens 150 is generally made of a high heat resistant material capable of standing a high temperature of around 300° C., wherein the wafer lens is manufactured through injection molding by a replica method in a wafer level state and a method for manufacturing the wafer lens will be described in detail afterward.

The substrate 130 closely adhered on a lower part of the housing 110 is mounted to the housing in a state that the image sensor 131 is mounted on a top surface of the substrate by a wire bonding method (COB) and the surface mounting pads 132 extended to each lateral lower surface of the substrate 130 are formed on each lateral surface of the substrate 130.

In accordance with the present invention, the camera module 100 mounted the above mentioned substrate 132 thereon is possible to be electrically connected without an additional electric connection device by directly being received on a main substrate (not shown) applied to a mounting terminal and directly being contacted with the main substrate through soldering the pads 132 to the main substrate.

Accordingly, the camera module using the substrate 130 with the surface mounting pads 132 is bonded and fixed without a connection device such as a connector or a socket or the like by soldering-bonding as being melting of a solder cream with passing through a reflow after being received on the main substrate coated with the solder cream.

At this time, the surface mounting pads may include a solder ball or a bump or the like. Further, the substrate 130 may selectively adopt a printed circuit board or a ceramic substrate.

Meanwhile, it is preferable that the lens barrel 120 is injection-molded by using the high heat resistant material capable of standing the heating temperature of around 150° C. the same as the housing 110.

At this time, the reason why the housing 110 and the lens barrel 120 should be made of the high heat resistant material is to stand the heating temperature (around 140° C.) in the reflow when passing through the reflow for soldering-bonding of the surface mounting pads 132 after receiving the camera module 100 on the main substrate.

Meanwhile, FIG. 6 is a cross-sectional view illustrating a camera module in accordance with another embodiment of the present invention and in the camera module 200 in accordance with the embodiment, a wafer lens 150 is mounted in a lens barrel 120 coupled on an upper part of a housing 110 and an IR coating layer 151 is formed on any one of a top surface and a bottom surface of the wafer lens 150.

Therefore, there is an advantage that the camera module 200 in accordance with the embodiment does not require the IR filter 140 to block the infrared rays included in the light impinged inside the housing 110 as shown in FIG. 5, thereby reducing a height of the camera module 200 as high as a thickness of the IR filter 140.

Further, in the camera module 200 in accordance with the embodiment, an image sensor 131 is wire-bonded on a substrate 130, wherein an additional adhesive B for protecting a contact region of a wire W is coated on a top surface of a pad 133 of the substrate 130 contacted with an end of the wire W for electrically connecting the substrate 130 and the image sensor 131.

That is to prevent damage of the wire W bonded on the pad 133 of the substrate 130 when the camera module 100 passes through the reflow in a state of being surface-mounted on a main substrate.

Hereinafter, the method for manufacturing the wafer lens 140 adopted for the camera module 100 in accordance with the present invention will be described more detailedly with reference to FIG. 7.

FIG. 7 is a flowchart illustrating the method for manufacturing the wafer lens adopted for the camera module in accordance with the present invention.

First of all, a polymer is poured in a mold with a plurality of grooves, a plurality of lens units are formed by curing with ultraviolet rays, and a substrate is bonded on rear surfaces of the lens units to be integrated.

Further, a lens array is manufactured by separating the mold from the lens units and a unit wafer lens 140 is produced by dicing each lens in an array state.

Herein, when the polymer is poured in the mold, a surface of the polymer is cure treated by the ultraviolet rays in a state of being exposed to the air to form the lens units by repeating such a process.

Further, when integrating the substrate on the rear surfaces of the lens units, the adhesive polymer is cured and then the lens units are integrally attached on the substrate as the transparent substrate is attached and the ultraviolet rays are irradiated through the transparent substrate.

And, the lens array arranged the plurality of lens units on a lateral surface of the substrate is manufactured by removing the mold from the lens units.

Deformation of the above described wafer lens 140 due to the contraction of the polymer is generated on other parts than a lens surface, that is, an exposed surface of the lens unit and therefore compensation for shape distortion of the lens surface is unnecessary, thus to manufacture the wafer lens with high quality of the lens units and a short focal length.

As described above, in accordance with the present invention, the camera module is capable of being surface-mounted through a reflow process with being received in a state that the solder cream is coated on the main substrate by being surface-mounted through a reflow process by closely coupling the substrate having the surface mounting pads on the lower end of the housing and also adopting the wafer lens made of the high heat resistant material capable of standing the heating temperature when passing through the reflow, thereby simplifying a process for mounting the camera module on the substrate and reducing a process cost by removing the additional connection device for electrically connecting the camera module onto the main substrate.

As described above, although a few preferable embodiments of the present invention have been shown and described, it will be appreciated by those skilled in the art that substitutions, modifications and changes may be made in these embodiments without departing from the principles and spirit of the general inventive concept, the scope of which is defined in the appended claims and their equivalents.

What is claimed is:

1. A camera module comprising:
a housing provided with a cylindrical barrel coupling unit extended upward from a central part of the housing, wherein a female screw unit is formed on an inner circumferential surface of the cylindrical barrel coupling unit and an opening unit is formed on a top portion of the cylindrical barrel coupling unit;
a lens barrel provided with a male screw unit on an outer circumferential surface by being formed in a cylindrical shape to be conformally combined with the barrel coupling unit and screw-coupled to the female screw unit by being inserted through the opening unit of the barrel coupling unit;
a wafer lens mounted in the lens barrel; and
a substrate with an image sensor mounted on a top surface of the substrate by a wire bonding and closely adhered to a lower part of the housing by being provided with surface mounting pads on each lateral surface of the substrate.

2. The camera module according to claim 1, wherein the lens barrel includes a disk-shaped cap on a top part.

3. The camera module according to claim 1, wherein the wafer lens is manufactured in an array type in a wafer level state by a replica method and diced to form a square-shaped unit wafer lens.

4. The camera module according to claim 3, wherein the wafer lens is stacked and coupled with at least one in the lens barrel and closely coupled by a pressurizing ring.

5. The camera module according to claim 4, wherein the wafer lens is fixed by fusing a contact interference of the lens barrel through ultrasonic waves or a laser irradiated outside the lens barrel.

6. The camera module according to claim 4, wherein the wafer lens includes an IR (Infra Red) coating layer on any one of a top surface and a bottom surface thereof.

7. The camera module according to claim 1, wherein the substrate selectively includes a solder ball and a bump on a bottom surface thereof.

8. The camera module according to claim 1, wherein the substrate selectively adopts any one of a printed circuit board or a ceramic substrate.

9. The camera module according to claim 1, wherein a rib is formed at an arbitrary spot inside the housing and an IR filter supported by the rib is incorporated inside the housing.

10. The camera module according to claim 1, wherein the housing and the lens barrel are injection-molded by using a high heat resistant material.

11. A camera module comprising:
a housing provided with a cylindrical barrel coupling unit extended upward from a central part of the housing, wherein a female screw unit is formed on an inner circumferential surface of the cylindrical barrel coupling unit and an opening unit is formed on a top portion of the cylindrical barrel coupling unit;
a lens barrel provided with a male screw unit on an outer circumferential surface by being formed in a cylindrical shape to be conformally combined with the barrel coupling unit and screw-coupled to the female screw unit by being inserted through the opening unit of the barrel coupling unit;
a wafer lens mounted in the lens barrel;
a substrate with an image sensor mounted on a top surface of the substrate by a wire bonding and closely adhered to a lower part of the housing by being provided with surface mounting pads on each lateral surface of the substrate; and
an adhesive coated to cover a wire bonding region at a top surface of a pad forming region of the substrate.
